(19) United States
(12) Patent Application Publication
(10) Pub. No.: US 2019/0275837 A1
(43) Pub. Date: Sep. 12, 2019

(54) REINFORCING PLY FOR ARTICLES MADE OF AN ELASTOMERIC MATERIAL, PREFERABLY FOR PNEUMATIC VEHICLE TYRES, AND PNEUMATIC VEHICLE TYRES

(71) Applicant: CONTINENTAL REIFEN DEUTSCHLAND GMBH, Hannover (DE)

(72) Inventors: Ute PÖHLER, Wedemark (DE); Carole JUSTINE, Scharrel (DE); Thomas KRAMER, Herford (DE)

(73) Assignee: Continental Reifen Deutschland GmbH, Hannover (DE)

(21) Appl. No.: 16/319,359

(22) PCT Filed: Jul. 4, 2017
(86) PCT No.: PCT/EP2017/066564

§ 371 Date: Jan. 21, 2019

(30) Foreign Application Priority Data
Aug. 2, 2016 (DE) 10 2016 214 276.3

(51) Int. Cl. B60C 9/00; B60C 9/20; D02G 3/48; C08L 67/02

(52) U.S. Cl. CPC B60C 9/0042; B60C 9/20; B60C 2009/0425; C08L 67/02; D02G 3/48

(57) ABSTRACT

The invention relates to a rubberized reinforcing ply for articles made of elastomeric material, preferably for pneumatic vehicle tires, where the reinforcing ply has a multitude of strength members which are arranged in parallel and spaced apart, where each strength member consists of at least one twisted multifilament yarn composed of polyethylene terephthalate (PET), where the multifilament yarn has a yarn count (linear density) of 50 to 1100 dtex and a linear density-based ultimate tensile strength of ≥70 cN/tex in accordance with ASTM D885-16, and where the rubberized material has a thickness D. The invention further relates to a pneumatic vehicle tire comprising this reinforcing ply.

The multifilament yarn has an elongation at break of 10% to 20% in accordance with ASTM D885-16, a crystallinity determined via DSC of 55% to 65% and a birefringence Δn with 0.21≤Δn≤0.25.

The invention relates to a rubberized reinforcing ply for articles made of elastomeric material, preferably for pneumatic vehicle tires, where the reinforcing ply has a multitude of strength members which are arranged in parallel and spaced apart, where each strength member consists of at least one twisted multifilament yarn composed of polyethylene terephthalate (PET), where the multifilament yarn has a yarn count (linear density) of 50 to 1100 dtex and a linear density-based ultimate tensile strength of ≥70 cN/tex in accordance with ASTM D885-16, and where the rubberized material has a thickness D. The invention further relates to a pneumatic vehicle tire comprising this reinforcing ply.

Reinforcing plies for articles made of elastomeric material, for example industrial rubber products and pneumatic vehicle tires, are of very great importance and are common knowledge to the person skilled in the art. The reinforcing plies have a multiplicity of reinforcing, thread-shaped elements, referred to as the strength members. They are embedded completely in elastomeric material. The strength members of these reinforcing plies have the form, for example, of fabric or of calendered, continuously coiled strength members.

The rubberized reinforcing plies of suitable size and design are joined to further components in order to form an industrial rubber product or a pneumatic vehicle tire. The rubberized reinforcing plies reinforce the product in question.

Strength members used for the reinforcing plies of rubber products may be a wide variety of different materials. There are known examples of strength members made of steel or textile strength members. Textile strength members used in the rubber industry include, for example, strength members made of rayon or polyester.

For the carcass of automobile tires, what are called HMLS polyester yarns have become established as strength members. Yarns of this kind are produced by spinning industrial polyester yarns under high tension and are notable for a high modulus and low shrinkage (high modulus low shrinkage). HMLS polyester multifilament yarns having a yarn count (linear density) of 1440 dtex are frequently used in the carcass of automobile tires. Yarns having this linear density have a relatively high diameter. This has the drawback of an elevated calendered ply thickness in the tire. This leads in turn to greater heat buildup in driving operation of the tire when these plies are subjected to churning forces. This buildup of heat results in losses in high-speed performance and in rolling resistance.

EP 0 908 329 B1 discloses providing rubberized reinforcing plies for the carcass of pneumatic vehicle tires with textile cords made of synthetic multifilament yarns made of the polyester types PET (polyethylene terephthalate) or PEN (polyethylene naphthalate). Owing to the yarn count used and the construction of the textile cords, they are comparatively thin, and so the rubberized reinforcing ply has a comparatively low ply thickness. This firstly has the advantage that less rubber material has to be used for rubberizing of these strength members, which saves material costs. Secondly, a thin rubberized reinforcing ply in the product, for example in the vehicle tire, has the advantage of a reduced weight of the tire. At the same time, the reduction in material thickness results in lower hysteresis, which has a positive effect on the rolling resistance of the tire.

Reinforcing plies according to the preamble of claim 1 and processes for production thereof are known, for example, from CN 104494169. The multifilament yarns used therein have a linear density of 500 to 1000 D and a modulus of 105 to 120 mN/dtex.

It is an object of the invention to provide a rubberized reinforcing ply which, while having adequate strength, has been further optimized in terms of its heat buildup in the resulting rubber products.

The object is achieved in that the multifilament yarn has an elongation at break of 10% to 20% in accordance with ASTM D885-16, a crystallinity determined via DSC of 55% to 65% and a birefringence Δn with 0.21≤Δn≤0.25.

“Multifilament yarn” here is understood to mean a multifilament yarn which has been twisted and hence as a strength member element has an x1 construction, and which has already undergone the operation of hot stretching, including impregnation.

It is possible to use the multifilament yarns having the properties mentioned to produce rubberized reinforcing plies which, in spite of a very small diameter, have high overall strength. The interplay of birefringence and crystallinity leads to greater orientation of the yarns, which seems to result in a higher strength. This enables a further improvement in heat buildup in the rubber products produced with these reinforcing plies. The even thinner multifilament yarns can further reduce the amount of rubberization material. As well as the saving of material costs, this results in a thinner rubberization ply which, when used, for example, as carcass ply in pneumatic vehicle tires, leads to a reduction in weight and distinctly lower heat buildup under the action of churning force and centrifugal force. The latter has a positive effect on rolling resistance and high-speed performance. The reinforcing ply of the invention, particularly in relation to breaking strength, modulus of elasticity, fatigue resistance and elongation at break, meets the demands for use particularly in a vehicle tire.

The multifilament yarn for the reinforcing ply of the invention is produced by spinning a raw yarn without any twisting, and subsequently twisting it in a twisting machine.

The multifilament yarn is converted to a fabric usable for calendering by conducting the following steps that are known to the person skilled in the art:
the twisting of the multifilament yarn(s) to give the desired strength member construction
the production of a fabric comprising the desired strength member
activating the fabric for rubber adhesion, for example by means of an RFL dip.

It is advantageous when the multifilament yarn has a yarn count (linear density) in the range from 420 dtex to 1100 dtex. In this way, particularly thin reinforcing plies are achievable in interplay with the high ultimate tensile strength. In particular, advantages are achieved in relation to the fatigue properties of a pneumatic vehicle tire that uses the reinforcing ply of the invention as carcass ply, and in relation to the processibility of the reinforcing ply production.

For use in articles made of elastomeric material that are regularly vulcanized, it has been found to be advantageous when the multifilament yarn has a hot shrinkage of less than 4% at 180° C. under a prestress of 0.1 cN/dtex with exposure time 2 min. Thus, the vulcanization of the products has a very minor influence on the multifilament yarn within the product.

In a preferred development of the invention, the multifilament yarn has an elongation at break in accordance with ASTM D885-16 of 10% to 15%. A pneumatic vehicle tire having such a reinforcing ply as carcass ply is more fatigue-resistant, even under extreme conditions such as contact with kerbstones.

For rubber products, especially pneumatic vehicle tires, it has been found to be advantageous when the linear density-based rubberization thickness GD, calculated by the following formula

GD=rubberization thickness D*(linear density/breaking strength),

of the rubberized reinforcing ply is between 1.0 mm*g/(m*cN) and 3.2 mm*g/(m*cN), the breaking strength being determined in accordance with ASTM D885-16. With reinforcing plies of this kind, when used in a pneumatic vehicle tire, particularly good results were achievable with regard to rolling resistance and suitability for high-speed use.

It is also advantageous when the strength member is a textile cord which consists of at least two mutually twisted polyethylene terephthalate multifilament yarns and is preferably arranged in a density of at least 130 epdm in the reinforcing ply.

“epdm” means ends per decimeter and describes, in a manner customary to the person skilled in the art, the cord density in the reinforcing ply.

In that case, it is appropriate when the polyethylene terephthalate multifilament yarns have a twist rate of 395 tpm (turns per meter) to 620 tpm and when the textile cord has an end twist rate of 395 tpm to 620 tpm. The twist factor α should accordingly be between 185 and 205. The twist factor α is defined as α=twist [t/m]*(linear density [tex]/1000)^{1/2}. The multifilament yarns may be S- or Z-twisted, while the end twist is in the opposite sense to the multifilament yarn twist.

Particularly suitable reinforcing plies have been found to be those having textile cords made of polyethylene terephthalate multifilament yarn with a construction of 550 dtex x2 to 1100 dtex x2. These textile cords are very thin and have very high fatigue resistance.

The invention is achieved in relation to the pneumatic vehicle tire in that said tire comprises an above-described rubberized reinforcing ply.

In this context, the reinforcing ply is especially a carcass and/or a bead reinforcement.

The invention is elucidated in detail hereinafter with reference to working examples, but without being limited thereto.

In a preferred working example of the invention, the reinforcing ply is used as carcass (carcass ply) for pneumatic automobile tires. The reinforcing ply is a rubberized fabric having, as strength members, textile cords composed of two mutually twisted polyethylene terephthalate multifilament yarns of construction 550×2 in a density of 175 epdm. The multifilament yarns each have a twist rate of 580 tpm and the textile cord in question has an end twist rate in the opposite sense of 580 tpm. The multifilament yarns have a linear density-based ultimate tensile strength of 72.7 cN/tex in accordance with ASTM D885-16 and the rubberization thickness is 0.80 mm. A value of 1.1 mm*g/(m*cN) is found for the linear density-based rubberization thickness GD. Elongation at break is 13.5% in accordance with ASTM D885-16. The multifilament yarn has a crystallinity of 56.6% and a birefringence of 0.210.

Crystallinity is determined by dynamic differential calorimetry (DSC) with an instrument from TA Instruments, by heating 2 to 5 mg of the multifilament yarn at a heating rate of 10 K per minute at first from room temperature to 300° C. in a first heating cycle, then cooling it from 300° C. to room temperature at 10 K per minute, and then heating it again in a second heating cycle from room temperature to 300° C. at a heating rate of 10 K per minute. Crystallinity was determined from the heat of fusion of the polymer and is reported as % crystallinity in relation to the heat of fusion of a 100% crystalline sample of the same material.

Birefringence was ascertained with a polarizing microscope (Olympus BX50) with Berek compensator. The sample was placed into the instrument in a diagonal position and the respective degree of rotation was determined with twisting to the right and left until the appearance of the sample was at its darkest. The difference in rotation was divided by 2 in order to obtain an angle of inclination. Using a reference table, the angle of inclination was used to determine the optical path difference γ in nm. The formula birefringence Δn=(optical path difference γ/thickness d) was used to calculate the birefringence, with determination of the thickness of the sample by means of a filar micrometer.

The pneumatic automobile tire equipped with this reinforcing ply as carcass ply is notable for high suitability for high-speed use, and it was possible to reduce rolling resistance by about 2% compared to a tire with a conventional PET carcass ply.

Table 1 below gives an overview of the parameters of PET textile cords of the aforementioned construction and the tires produced therefrom with the rolling resistance ascertained.

TABLE 1

| Example/Parameter | 1 | Comparison |
|---|---|---|
| Material | PET | PET |
| Cord construction | 550 × 2 | 1100 × 2 |
| Yarn count [dtex] | 550 | 1100 |
| Twists [tpm] | 580 | 410 |
| Diameter [mm] | 0.38 | 0.54 |
| Linear density-based ultimate | 72.7 | 62.7 |
| tensile strength [cN/tex] | | |
| Rubberization thickness [mm] | 0.80 | 0.95 |
| Linear density-based rubberization | 1.1 | 3.3 |
| thickness [mm*g/(m*cN)] | | |
| Elongation at break [%] | 13.5 | 14.7 |
| Crystallinity [%] | 56.6 | 52.2 |
| Birefringence [−] | 0.21 | 0.20 |
| Tire | | |
| Cord density [epdm] | 175 | 110 |
| Rolling resistance [%] | 102 | 100 |

A rolling resistance of 100% corresponds to the reference. Rolling resistances>100% indicate lowered (improved) rolling resistance, whereas rolling resistances<100% indicate elevated (worsened) rolling resistance.

Table 2 below shows the properties of PET textile cords with identical cord construction (1100×2).

TABLE 2

| Example/Parameter | 2 | Comparison |
|---|---|---|
| Material | PET | PET |
| Cord construction | 1100 × 2 | 1100 × 2 |
| Yarn count [dtex] | 1100 | 1100 |
| Twists [tpm] | 410 | 410 |
| Diameter [mm] | 0.54 | 0.54 |
| Linear density-based ultimate | 72.7 | 62.7 |
| tensile strength [cN/tex] | | |
| Rubberization thickness [mm] | 0.95 | 0.95 |
| Linear density-based rubberization | 2.8 | 3.3 |
| thickness [mm*g/(m*cN)] | | |
| Elongation at break [%] | 14.4 | 14.7 |
| Crystallinity [%] | 56.0 | 52.2 |
| Birefringence [−] | 0.21 | 0.20 |

For the same cord construction, the linear density-based ultimate tensile strength is higher, which is also manifested in the higher crystallinity and birefringence. This makes it possible to switch to thinner cord diameters. Linear density-based rubberization thickness is reduced in the reinforcing ply of the invention.

1.-10. (canceled)

11. A rubberized reinforcing ply for articles made of elastomeric material, wherein the reinforcing ply comprises a multitude of strength members which are arranged in parallel and spaced apart, wherein each strength member consists of at least one twisted multifilament yarn composed of polyethylene terephthalate (PET), wherein the multifilament yarn has a yarn count (linear density) of 50 to 1100 dtex and a linear density-based ultimate tensile strength of ≥70 cN/tex in accordance with ASTM D885-16, and wherein the rubberized material has a thickness D; and,
wherein the multifilament yarn has an elongation at break of 10% to 20% in accordance with ASTM D885-16, a crystallinity determined via DSC of 55% to 65% and a birefringence Δn with 0.21≤Δn≤0.25.

12. The reinforcing ply as claimed in claim 11, wherein the multifilament yarn has a yarn count (linear density) of 420 dtex to 1100 dtex.

13. The reinforcing ply as claimed in claim 11, wherein the multifilament yarn has a hot shrinkage of less than 4% at 180° C. under a prestress of 0.1 cN/dtex with exposure time 2 min.

14. The reinforcing ply as claimed in claim 11, wherein the multifilament yarn has an elongation at break in accordance with ASTM D885-16 of 10% to 15%.

15. The reinforcing ply as claimed in claim 11 having a linear density-based rubberization thickness GD calculated by the following formula GD=rubberization thickness D*(linear density/breaking strength) between 1.0 mm*g/(m*cN) and 3.2 mm*g/(m*cN), the breaking strength being determined in accordance with ASTM D885-16.

16. The reinforcing ply as claimed in claim 11, wherein each of the strength members is a textile cord consisting of at least two mutually twisted polyethylene terephthalate multifilament yarns and wherein the strength members are arranged in the reinforcing ply in a density of at least 130 epdm.

17. The reinforcing ply as claimed in claim 16, wherein the multifilament yarns have a twist rate of 395 tpm to 620 tpm and in that the textile cord has an end twist rate of 395 tpm to 620 tpm.

18. The reinforcing ply as claimed in claim 16, wherein each of the textile cord has a construction of 550 dtex x2 to 1100 dtex x2.

19. The reinforcing ply as claimed in claim 11, wherein the articles made of elastomeric material are pneumatic vehicle tires.

20. The reinforcing ply as claimed in claim 11, wherein the reinforcing ply is incorporated in a carcass of a pneumatic vehicle tire.

21. The reinforcing ply as claimed in claim 11, wherein the reinforcing ply is incorporated in a bead reinforcement of a pneumatic vehicle tire.

22. The reinforcing ply as claimed in claim 11, wherein the reinforcing ply is incorporated in a carcass and a bead reinforcement of a pneumatic vehicle tire.

23. A rubberized reinforcing ply for articles made of elastomeric material, wherein the reinforcing ply comprises a multitude of strength members which are arranged in parallel and spaced apart, wherein each strength member consists of at least one twisted multifilament yarn composed of polyethylene terephthalate (PET), wherein the multifilament yarn has a yarn count (linear density) of 50 to 1100 dtex and a linear density-based ultimate tensile strength of ≥70 cN/tex in accordance with ASTM D885-16, and wherein the rubberized material has a thickness D;
wherein the multifilament yarn has an elongation at break of 10% to 20% in accordance with ASTM D885-16, a crystallinity determined via DSC of 55% to 65% and a birefringence Δn with 0.21≤Δn≤0.25;
wherein each of the strength members are textile cords consisting of at least two mutually twisted polyethylene terephthalate multifilament yarns and wherein the strength members are arranged in the reinforcing ply in a density of at least 130 epdm; and,
wherein the multifilament yarns have a twist rate of 395 tpm to 620 tpm and in that each of the textile cord has an end twist rate of 395 tpm to 620 tpm and a twist factor α of between 185 and 205.

24. The reinforcing ply as claimed in claim 23, wherein each of the textile cords has a construction of 550 dtex x2 to 1100 dtex x2.

25. The reinforcing ply as claimed in claim 23, wherein the multifilament yarn has a yarn count (linear density) of 420 dtex to 1100 dtex.

26. The reinforcing ply as claimed in claim 23, wherein the multifilament yarn has a hot shrinkage of less than 4% at 180° C. under a prestress of 0.1 cN/dtex with exposure time 2 min.

27. The reinforcing ply as claimed in claim 23, wherein the multifilament yarn has an elongation at break in accordance with ASTM D885-16 of 10% to 15%.

28. The reinforcing ply as claimed in claim 23 having a linear density-based rubberization thickness GD calculated by the following formula GD=rubberization thickness D*(linear density/breaking strength) between 1.0 mm*g/(m*cN) and 3.2 mm*g/(m*cN), the breaking strength being determined in accordance with ASTM D885-16.

29. The reinforcing ply as claimed in claim 23, wherein the articles made of elastomeric material are pneumatic vehicle tires.

30. The reinforcing ply as claimed in claim 23, wherein the reinforcing ply is incorporated in one or more of a carcass or a bead reinforcement of a pneumatic vehicle tire.
